(19) United States
(12) Patent Application Publication
(10) Pub. No.: US 2017/0195864 A1
(43) Pub. Date: Jul. 6, 2017

(54) Emergency Communication Method and Electronic Device

(71) Applicants: Le Holdings (Beijing) Co., Ltd., Beijing (CN); Lemobile Information Technology (Beijing) Co., Ltd, Beijing (CN)

(72) Inventor: Tianyu Li, Beijing (CN)

(21) Appl. No.: 15/241,423

(22) Filed: Aug. 19, 2016

Related U.S. Application Data
(63) Continuation of application No. PCT/CN2016/088334, filed on Jul. 4, 2016.

(30) Foreign Application Priority Data
Dec. 31, 2015 (CN) 201511031096.9

(51) Int. Cl. H04W 4/22; G08B 25/01; G08B 25/12; G08B 7/06; H04W 4/02; G08B 25/00

(52) U.S. Cl. CPC H04W 4/22; H04W 4/02; G08B 25/006; G08B 25/12; G08B 7/06; G08B 25/014

(57) ABSTRACT

The application provides an emergency communication method and an electronic device. The method includes the following steps: acquiring button input information; finding a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and executing the preset communication operation in the target predetermined solution.

### CROSS REFERENCE TO RELATED APPLICATIONS

This application is a continuation of International Application No. PCT/CN2016/088334, filed on Jul. 4, 2016, which is based upon and claims priority to Chinese Patent Application No. 201511031096.9, filed on Dec. 31, 2015, titled “Emergency Communication Method and Device”, the entire contents of which are incorporated herein by reference.

### TECHNICAL FIELD

The application relates to the field of control over intelligent terminals, and particularly relates to an emergency communication method and an electronic device.

### BACKGROUND

In today's environment, such intelligent communication terminals as mobile phones, etc. have already become indispensable communication and living tools of users. The functions of communication terminals become abundant gradually. To ensure that the users quickly conduct emergency communication under a critical environment, a mobile phone having the function of “One Touch SOS” already exists at present. Specifically, the users are generally allowed to set the information of an emergency contact person in a mobile phone system and a unique button is arranged on the mobile phone. The users can operate the button for quickly calling the emergency contact person, and can also directly or indirectly transmit prompt information to the emergency contact person.

In real life, there are many application scenarios where the users need help, e.g., the situations that the users suddenly feel unwell and the safety of the users is threatened by people or things. In these application scenarios, the users are to give a call for help in some environments, so as to perform voice with the emergency contact person, but under some very emergency conditions, users may have only several seconds for help, the users are not allowed to perform voice communication due to environmental factors, and the transmitted prompt information cannot accurately express crisis situations encountered by the users. It can be seen that the existing emergency communication solution in a “One Touch SOS” mode is poor in convenience and flexibility and cannot meet actual needs.

### SUMMARY

The application discloses an emergency communication method and an electronic device, which can overcome the defects of poor convenience and flexibility of the emergency communication solution in the prior art.

Thus, one objective of the embodiments of the application is to provide an emergency communication method, including the following steps: acquiring button input information; finding a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and executing the preset communication operation in the target predetermined solution.

Preferably, before acquiring the button input information, further including: acquiring preset button position information and a preset communication operation; judging whether the currently acquired preset button position information is the same as the preset button position information in the prestored predetermined solutions; generating a predetermined solution by using the currently acquired preset button position information and preset communication operation if the currently acquired preset button position information is different from the preset button position information in the prestored predetermined solutions; and storing the generated predetermined solution.

Preferably, the preset communication operations include performing voice communication with a preset contact person and/or transmitting preset communication information to the preset contact person.

Preferably, the preset communication operations include transmitting to the preset contact person current position information and time information when transmitting the position information.

Preferably, the predetermined solutions further include a terminal state setting operation; and further include executing the terminal state setting operation in the target predetermined solution after finding the target predetermined solution from at least one prestored predetermined solution.

Another objective of the embodiments of the application is to provide an electronic device, including: at least one processor; and a memory communicably connected with the at least one processor for storing instructions executable by the at least one processor, wherein execution of the instructions by the at least one processor causes the at least one processor to: acquire button input information; find a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and execute the preset communication operation in the target predetermined solution.

The electronic device, wherein, the electronic device further including acquiring preset button position information and a preset communication operation; judging whether the currently acquired preset button position information is the same as the preset button position information in the prestored predetermined solutions; generating a predetermined solution by using the currently acquired preset button position information and preset communication operation if the currently acquired preset button position information is different from the preset button position information in the prestored predetermined solutions; and storing the generated predetermined solution.

The electronic device, wherein, the preset communication operations include performing voice communication with a preset contact person and/or transmitting preset communication information to the preset contact person.

The electronic device, wherein, the preset communication operations include transmitting to the preset contact person current position information and time information when transmitting the position information.

The electronic device, wherein, the predetermined solutions further include a terminal state setting operation; and further include executing the terminal state setting operation in the target predetermined solution after finding the target predetermined solution from at least one prestored predetermined solution.

A further objective of the embodiments of the application is to provide a non-transitory computer-readable storage medium storing executable instructions that, when executed by an electronic device, cause the electronic device to: acquire button input information; find a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and execute the preset communication operation in the target predetermined solution.

Wherein, before acquiring the button input information, further including: acquiring preset button position information and a preset communication operation; judging whether the currently acquired preset button position information is the same as the preset button position information in the prestored predetermined solutions; generating a predetermined solution by using the currently acquired preset button position information and preset communication operation if the currently acquired preset button position information is different from the preset button position information in the prestored predetermined solutions; and storing the generated predetermined solution.

Wherein, the preset communication operations include performing voice communication with a preset contact person and/or transmitting preset communication information to the preset contact person.

Wherein, the preset communication operations include transmitting to the preset contact person current position information and time information when transmitting the position information.

Wherein, the predetermined solutions further include a terminal state setting operation; and further include executing the terminal state setting operation in the target predetermined solution after finding the target predetermined solution from at least one prestored predetermined solution.

The emergency communication method and electronic device provided by the embodiments of the application include acquiring button input information; finding a target predetermined solution from at least one prestored predetermined solution according to the acquired button input information; and executing preset communication operation in the target predetermined solution after determining the target predetermined solution. Thus, in the solution, different predetermined communication operations can be executed according to different button inputs by a user, thereby enhancing convenience and flexibility of an emergency communication operation.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of an emergency communication method provided by the application.

FIG. 2 is a structural diagram of an emergency communication device provided by the application.

FIG. 3 shows a schematic diagram of the hardware configuration of the electronic device in accordance with the embodiments of the application.

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

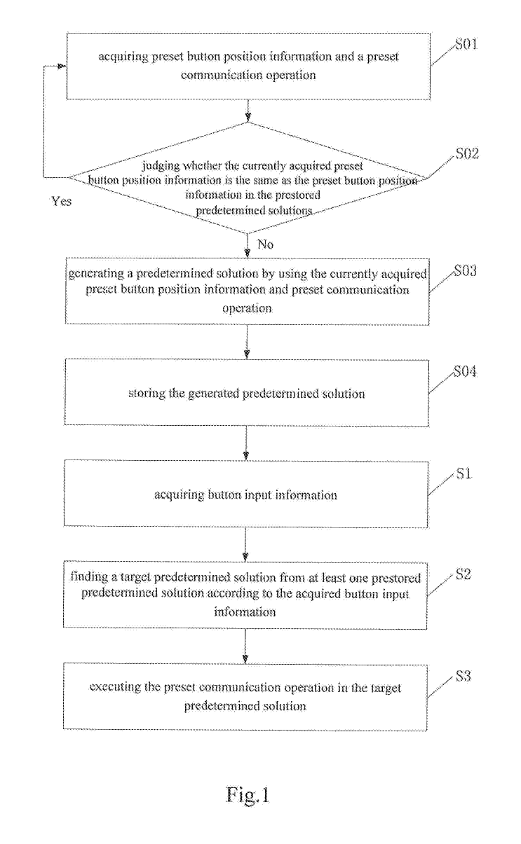

The embodiments of the application provide an emergency communication method. The method can be executed by an intelligent communication terminal. As shown in FIG. 1, the method includes the following steps:

S1. acquiring button input information which can be information inputted by operating a single button by the user or information inputted by operating a plurality of buttons (a combination of buttons) by the user in a certain order, wherein the button of the application can be a virtual button provided by an intelligent terminal system or an existing mechanical button on the terminal or a button added on the terminal; and if the current user successively operates a number button 1, a number button 2 and a number button 3, the terminal acquires the information “123” (the above buttons and information are merely simple examples given for illustrating the technical solution of the application; the application does not limit the specific contents of the buttons and the input information; and in practical application, simpler or more complicated button combinations as well as input information corresponding to the buttons can be set);

S2. finding a target predetermined solution from at least one prestored predetermined solution according to the acquired button input information, wherein each prestored predetermined solution includes preset button position information and a preset communication operation (specifically, the preset communication operation can be a command or information for controlling the terminal to take a certain communication action, and the terminal can take the communication action according to the control command or information), the prestored predetermined solutions have different preset button position information and different preset communication operations, and the preset button position information in the target predetermined solution is consistent with the acquired button input information;

wherein if three predetermined solutions are stored in the terminal, then a predetermined solution 1 includes preset button position information “123” and a preset communication operation 1, a predetermined solution 2 includes preset button position information “456” and a preset communication operation 2, and a predetermined solution 3 includes preset button position information “789” and a preset communication operation 3; after the button input information is acquired, each predetermined solution is judged one by one; when the button input information is consistent with the preset button position information in a certain prestored predetermined solution, step S3 is executed; from the above, because the information acquired in step S1 is “123” and is consistent with the preset button position information “123” in the predetermined solution 1, S3 is executed; if the button input information acquired in step S1 is not consistent with any one of prestored preset button position information, subsequent operations are not executed; a prompt that there is no predetermined solution matched with the current operation of the user in the system can be given; then the operation is returned and the input operation of the user is continuously monitored; and

S3. executing the preset communication operation in the target predetermined solution, wherein the preset communication operation includes multiple contents, e.g., transmitting predetermined information to a predetermined contact person and calling the predetermined contact person, and even more complicated predetermined communication actions are feasible; in order to avoid an emergency communication process caused by misoperation of the user, a prompt option can pop up to prompt the user to conduct final confirmation when the communication operation is executed finally; and after the user confirms, the communication operation is executed.

The emergency communication method provided in the application includes acquiring button input information; finding a target predetermined solution from at least one prestored predetermined solution according to the acquired button input information; and executing preset communication operation in the target predetermined solution after determining the target predetermined solution. Thus, in the solution, different predetermined communication operations can be executed according to different button inputs by a user, thereby enhancing convenience and flexibility of an emergency communication operation.

As a preferred embodiment, the solution can also allow the user to autonomously set contents of the predetermined solutions. That is, before step S1, the solution can also include a step of acquiring the predetermined solutions, specifically including:

S01. acquiring preset button position information and a preset communication operation, wherein the preset button position information and the preset communication operation can be set by the user, and any button, any button combination and various communication actions can be set;

S02. judging whether the currently acquired preset button position information is the same as the preset button position information in the prestored predetermined solutions, so as to prevent the user from setting repeated preset buttons or button combinations; if the currently acquired preset button position information in a predetermined solution is different from the preset button position information in the prestored predetermined solutions, step S03 is executed; otherwise, the user can be prompted to reset the preset button position and return to step S01;

S03. generating the predetermined solution by using the currently acquired preset button position information and preset communication operation, allowing the user to name the currently generated predetermined solution and displaying the name of the corresponding predetermined solution when executing the preset communication operation; and

S04. storing the generated predetermined solution as a prestored predetermined solution.

The above preferred solution can accept the user-defined preset button position information and preset communication operation, and generate the predetermined solution according to the user-defined information, thereby further enhancing the flexibility of the emergency communication operation; and in the process of generating the predetermined solution, a step of judging whether the currently acquired preset button position information is the same as the preset button position information in the prestored predetermined solutions is also added, thereby preventing the user from repeatedly setting button positions.

As a preferred embodiment, the above preset communication operations can include performing voice communication with a preset contact person and/or transmitting preset communication information to the preset contact person; the user can designate an emergency contact person in advance in accordance with each predetermined solution, and edit and store message contents in advance; messages can be text information, picture information, voice information, etc.; and the messages can be transmitted by a cellular network or a WiFi network. In the above preferred solution, when the user performs a simple emergency communication operation, the information or call is automatically transmitted to the designated contact person, so that the designated contact person receives the information or call while the communication operation contents of the user are reduced.

As another preferred embodiment, the above preset communication operations can include transmitting to the preset contact person current position information and time information when transmitting the position information, and specifically include automatically starting a GPS module of the terminal to receive the position information and transmitting the position information to the preset contact person according to a predetermined time interval. In the above preferred solution, when the user performs a simple emergency communication operation, the current position of the user and the current time are automatically transmitted to the designated contact person, so that the designated contact person obtains the positions of the user and specific time in each position while the communication operation contents of the user are reduced.

As another preferred embodiment, the predetermined solutions can also include a terminal state setting operation; the terminal state setting operation includes multiple types, e.g., controlling the terminal to continuously vibrate and/or controlling the terminal to play a bell (alarm sound) and/or controlling a terminal screen or a flash lamp to start, flash, etc., all of which are feasible.

Meanwhile, after the above step S2, the step of the terminal state setting operation in the target predetermined solution can also be executed. The above preferred solution can control the terminal to cooperate to take certain physical actions in emergency communication, and the actions can enable the terminal to achieve the effect of identification to adapt to multiple emergency scenarios.

### Embodiment 2

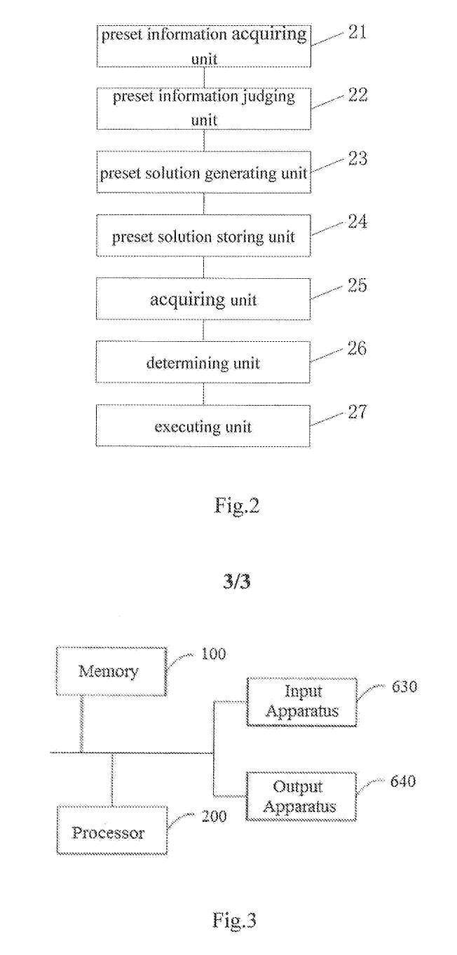

Another embodiment of the application further provides an emergency communication device. As shown in FIG. 2, the emergency communication device includes:

an acquiring unit 25 used for acquiring button input information;

a determining unit 26 used for finding a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and

an executing unit 27 used for executing the preset communication operation in the target predetermined solution.

The emergency communication device provided in the application includes acquiring button input information; finding a target predetermined solution from at least one prestored predetermined solution according to the acquired button input information; and executing preset communication operation in the target predetermined solution after determining the target predetermined solution. Thus, in the solution, different predetermined communication operations can be executed according to different button inputs by a user, thereby enhancing convenience and flexibility of an emergency communication operation.

Preferably, the emergency communication device further includes:

a preset information acquiring unit 21 used for acquiring preset button position information and a preset communication operation;

a preset information judging unit 22 used for judging whether the currently acquired preset button position information is the same as the preset button position information in the prestored predetermined solutions;

a preset solution generating unit 23 used for generating a predetermined solution by using the currently acquired preset button position information and preset communication operation if the currently acquired preset button position information is different from the preset button position information in the prestored predetermined solutions; and

a preset solution storing unit 24 used for storing the generated predetermined solution.

The above solution can accept the user-defined preset button position information and preset communication operation, and generate the predetermined solution according to the user-defined information, thereby further enhancing the flexibility of the emergency communication operation; and in the process of generating the predetermined solution, a step of judging whether the currently acquired preset button position information is the same as the preset button position information in the prestored predetermined solutions is also added, thereby preventing the user from repeatedly setting button positions.

Preferably, the preset communication operations include performing voice communication with a preset contact person and/or transmitting preset communication information to the preset contact person. In the above preferred solution, when the user performs a simple emergency communication operation, the information or call is automatically transmitted to the designated contact person, so that the designated contact person receives the information or call while the communication operation contents of the user are reduced.

Preferably, the preset communication operations include transmitting to the preset contact person current position information and time information when transmitting the position information. In the above preferred solution, when the user performs a simple emergency communication operation, the current position of the user and the current time are automatically transmitted to the designated contact person, so that the designated contact person obtains the positions of the user and specific time in each position while the communication operation contents of the user are reduced.

Preferably, the predetermined solutions further include a terminal state setting operation; and the emergency communication device further includes: a terminal state setting unit used for executing the terminal state setting operation in the target predetermined solution. The above preferred solution can control the terminal to cooperate to take certain physical actions in emergency communication, and the actions can enable the terminal to achieve the effect of identification to adapt to multiple emergency scenarios.

### Embodiment 3

The embodiment of the application provides a non-transitory computer-readable storage medium storing executable instructions that, when executed by an electronic device, cause the electronic device to: acquire button input information; find a target predetermined solution from at least one prestored predetermined solution according to the acquired button input information, wherein each prestored predetermined solution includes preset button position information and a preset communication operation, the prestored predetermined solutions have different preset button position information and different preset communication operations, and the preset button position information in the target predetermined solution is consistent with the acquired button input information; and execute the preset communication operation in the target predetermined solution.

As a preferred embodiment, before acquiring the button input information, further including: acquiring preset button position information and a preset communication operation; judging whether the currently acquired preset button position information is the same as the preset button position information in the prestored predetermined solutions; generating a predetermined solution by using the currently acquired preset button position information and preset communication operation if the currently acquired preset button position information is different from the preset button position information in the prestored predetermined solutions; and storing the generated predetermined solution.

As a preferred embodiment, the preset communication operations include performing voice communication with a preset contact person and/or transmitting preset communication information to the preset contact person.

As a preferred embodiment, the preset communication operations include transmitting to the preset contact person current position information and time information when transmitting the position information.

As a preferred embodiment, the predetermined solutions further include a terminal state setting operation; and further include executing the terminal state setting operation in the target predetermined solution after finding the target predetermined solution from at least one prestored predetermined solution.

### Embodiment 4

FIG. 3 is a schematic diagram of the hardware configuration of the electronic device provided by the embodiment, which performs the emergency communication method. As shown in FIG. 3, the electronic device includes: one or more processors 200 and a memory 100, wherein one processor 200 is shown in FIG. 3 as an example. The electronic device that performs emergency communication method further includes an input apparatus 630 and an output apparatus 640.

The processor 200, the memory 100, the input apparatus 630 and the output apparatus 640 may be connected via a bus line or other means, wherein connection via a bus line is shown in FIG. 3 as an example.

The memory 100 is a non-transitory computer-readable storage medium that can be used to store non-transitory software programs, non-transitory computer-executable programs and modules, such as the program instructions/modules corresponding to the emergency communication method of the embodiments of the application (e.g. preset information acquiring unit 21, preset information judging unit 22, preset solution generating unit 23, preset solution storing unit 24, acquiring unit 25, determining unit 26 and executing unit shown in the FIG. 2). The processor 200 executes the non-transitory software programs, instructions and modules stored in the memory 100 so as to perform various function application and data processing of the server, thereby implementing the emergency communication method of the above-mentioned method embodiments

The memory 100 includes a program storage area and a data storage area, wherein, the program storage area can store an operation system and application programs required for at least one function; the data storage area can store data generated by use of the emergency communication device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the emergency communication device via network connection. Examples of the aforementioned network include but not limited to internet, intranet, LAN, GSM, and their combinations.

The input apparatus 630 receives digit or character information, so as to generate signal input related to the user configuration and function control of the emergency communication device. The output apparatus 640 includes display devices such as a display screen.

The one or more modules are stored in the memory 100 and, when executed by the one or more processors 200, perform the emergency communication method of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

What is claimed is:

1. An emergency communication method, comprising the following steps:
acquiring button input information;
finding a target predetermined solution from at least one prestored predetermined solution according to the acquired button input information, wherein each prestored predetermined solution comprises preset button position information and a preset communication operation, the prestored predetermined solutions have different preset button position information and different preset communication operations, and the preset button position information in the target predetermined solution is consistent with the acquired button input information; and
executing the preset communication operation in the target predetermined solution.

2. The emergency communication method of claim 1, before acquiring the button input information, further comprising:
acquiring preset button position information and a preset communication operation;
judging whether the currently acquired preset button position information is the same as the preset button position information in the prestored predetermined solutions;
generating a predetermined solution by using the currently acquired preset button position information and preset communication operation if the currently acquired preset button position information is different from the preset button position information in the prestored predetermined solutions; and
storing the generated predetermined solution.

3. The emergency communication method of claim 1, wherein, the preset communication operations comprise performing voice communication with a preset contact person and/or transmitting preset communication information to the preset contact person.

4. The emergency communication method of claim 1, wherein, the preset communication operations comprise transmitting to the preset contact person current position information and time information when transmitting the position information.

5. The emergency communication method of claim 1, wherein, the predetermined solutions further comprise a terminal state setting operation; and further comprise executing the terminal state setting operation in the target predetermined solution after finding the target predetermined solution from at least one prestored predetermined solution.

6. An electronic device, comprising: at least one processor; and a memory communicably connected with the at least one processor for storing instructions executable by the at least one processor, wherein execution of the instructions by the at least one processor causes the at least one processor to:
acquire button input information;
find a target predetermined solution from at least one prestored predetermined solution according to the acquired button input information, wherein each prestored predetermined solution comprises preset button position information and a preset communication operation, the prestored predetermined solutions have different preset button position information and different preset communication operations, and the preset button position information in the target predetermined solution is consistent with the acquired button input information; and
execute the preset communication operation in the target predetermined solution.

7. The electronic device of claim 6, further comprising:
acquiring preset button position information and a preset communication operation;
judging whether the currently acquired preset button position information is the same as the preset button position information in the prestored predetermined solutions;
generating a predetermined solution by using the currently acquired preset button position information and preset communication operation if the currently acquired preset button position information is different from the preset button position information in the prestored predetermined solutions; and
storing the generated predetermined solution.

8. The electronic device of claim 6, wherein, the preset communication operations comprise performing voice communication with a preset contact person and/or transmitting preset communication information to the preset contact person.

9. The electronic device of claim 6, wherein, the preset communication operations comprise transmitting to the preset contact person current position information and time information when transmitting the position information.

10. The electronic device of claim 6, wherein, the predetermined solutions further comprise a terminal state setting operation; and further comprise executing the terminal state setting operation in the target predetermined solution after finding the target predetermined solution from at least one prestored predetermined solution.

11. A non-transitory computer-readable storage medium storing executable instructions that, when executed by an electronic device, cause the electronic device to:
acquire button input information;
find a target predetermined solution from at least one prestored predetermined solution according to the acquired button input information, wherein each prestored predetermined solution comprises preset button position information and a preset communication operation, the prestored predetermined solutions have different preset button position information and different preset communication operations, and the preset button position information in the target predetermined solution is consistent with the acquired button input information; and
execute the preset communication operation in the target predetermined solution.

12. The non-transitory computer-readable storage medium of claim 11, before acquiring the button input information, further comprising:
acquiring preset button position information and a preset communication operation;
judging whether the currently acquired preset button position information is the same as the preset button position information in the prestored predetermined solutions;
generating a predetermined solution by using the currently acquired preset button position information and preset communication operation if the currently acquired preset button position information is different from the preset button position information in the prestored predetermined solutions; and
storing the generated predetermined solution.

13. The non-transitory computer-readable storage medium of claim 11, wherein, the preset communication operations comprise performing voice communication with a preset contact person and/or transmitting preset communication information to the preset contact person.

14. The non-transitory computer-readable storage medium of claim 11, wherein, the preset communication operations comprise transmitting to the preset contact person current position information and time information when transmitting the position information.

15. The non-transitory computer-readable storage medium of claim 11, wherein, the predetermined solutions further comprise a terminal state setting operation; and further comprise executing the terminal state setting operation in the target predetermined solution after finding the target predetermined solution from at least one prestored predetermined solution.
